(19) United States
(12) Patent Application Publication
(10) Pub. No.: US 2026/0103275 A1
(43) Pub. Date: Apr. 16, 2026

(54) DYNAMIC TOPOLOGICAL CONTROL OF METAMORPHIC STRUCTURES

(71) Applicant: Infinite Concepts Incorporated, Orlando, FL (US)

(72) Inventor: Alfonso Alexander Perez, Orlando, FL (US)

(21) Appl. No.: 19/359,488

(22) Filed: Oct. 15, 2025

Related U.S. Application Data
(60) Provisional application No. 63/708,111, filed on Oct. 16, 2024.

(51) Int. Cl. B64C 3/54; B64C 3/26

(52) U.S. Cl. CPC B64C 3/54; B64C 3/26

(57) ABSTRACT

Provided herein is a dynamic topographical metamorphic structure for aerial flight. The structure may include an aerial body. An aerial body may include a first wing having a first metamorphic stricture configured to change its dimensional attributes while retaining structural integrity. A first wing may have a first cable connected to a first metamorphic structure. An aerial body may include a second wing having a second metamorphic stricture configured to change its dimensional attributes while retaining structural integrity. A second wing may have a second cable connected to a second metamorphic structure. A control device may be configured to activate first and/or second pulleys to change dimensional attributes of a first and/or second metamorphic structure to adjust flight parameters of an aerial body.

### CROSS-REFERENCE TO RELATED APPLICATIONS

This application claims priority to, and the benefit of, U.S. Prov. No. 63/708,111, filed Oct. 16, 2024, the entirety of which is incorporated herein by reference.

### TECHNICAL FIELD

The present disclosure relates to metamorphic structures. In particular, the present disclosure relates to dynamic topological control of metamorphic structures.

### SUMMARY

Provided herein is a dynamic topographical control system for metamorphic structures. The system may include a computing device. A computing device may be configured to receive flight parameters of at least a metamorphic structure. A computing device may be configured to calculate structure parameters of at least a metamorphic structure based on at least flight parameters. A computing device may be configured to update structed parameters based on new flight parameters cased by updated structure parameters.

Provided herein is a dynamic topographical metamorphic structure for aerial flight. The structure may include an aerial body. An aerial body may include a first wing having a first metamorphic stricture configured to change its dimensional attributes while retaining structural integrity. A first wing may have a first cable connected to a first metamorphic structure. A first wing may have a first pulley connected to a first cable. A first pully may be configured to provide a force on a first cable to change one or more dimensional attributes of a first metamorphic structure. An aerial body may include a second wing having a second metamorphic stricture configured to change its dimensional attributes while retaining structural integrity. A second wing may have a second cable connected to a second metamorphic structure. A second wing may have a first pulley connected to a second cable. A second pully may be configured to provide a force on a second cable to change one or more dimensional attributes of a second metamorphic structure. A structure may include a control device in communication with first and second pulleys. A control device may be configured to activate first and/or second pulleys to change dimensional attributes of a first and/or second metamorphic structure to adjust flight parameters of an aerial body.

The above and other preferred features, including various novel details of implementation and combination of elements, will now be more particularly described with reference to the accompanying drawings and pointed out in the claims. It will be understood that the particular methods and apparatuses are shown by way of illustration only and not as limitations. As will be understood by those skilled in the art, the principles and features explained herein may be employed in various and numerous embodiments.

### BRIEF DESCRIPTION OF THE DRAWINGS

The disclosed embodiments have advantages and features which will be more readily apparent from the detailed description, the appended claims, and the accompanying figures (or drawings). A brief introduction of the figures is below.

FIG. 1 illustrates a dynamic topographical control system for metamorphic structures;

FIGS. 2A-B illustrate embodiments of an aerial vehicle;

FIG. 3 illustrates another embodiment of an aerial vehicle;

FIG. 4 illustrates another embodiment of an aerial vehicle;

FIG. 5 illustrates pulley subsystem;

FIG. 6 illustrates a metamorphic bike;

FIG. 7 illustrates a wing and body system;

FIG. 8 illustrates another wing and body system;

FIG. 9A-B illustrates a tensile harmonic manifold control surface and a non-stationary point rotation device;

FIG. 10 illustrates a deployment of an unmanned aerial vehicle;

FIG. 11 illustrates an aerial vehicle;

FIG. 12 illustrates a joint of an aerial vehicle;

FIG. 13 illustrates a truss of an aerial vehicle; and

FIG. 14 illustrates a tool path of a metamorphic structure.

### DETAILED DESCRIPTION

The Figures (Figs.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be use in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

Due to early failures of airplanes in the 1900-1940's, especially those manned aircraft relying on wing warping for steering, the design community largely abandoned the field in favor of the industry standard aileron, taileron, rudders, & flaps flight path control paradigm. Similar control strategies remain commonplace in aquatic regimes as well. The author acknowledges the utility of these systems for modest pitch, roll, yaw control of commercial or otherwise manned aircraft where the targeted uses are primarily for stable flight and controlled takeoff/landing. Engineers rely heavily on independent control of ailerons, tailerons, rudders, and flaps to deliver these core functions. These complex, multi-component surface control subsystems dominant in fixed wing aviation systems, typically, though not exclusively hydraulically actuated, are expensive to build, costly to maintain, and only offer a moderate degree of aerobatic (or hydrobatic) control.

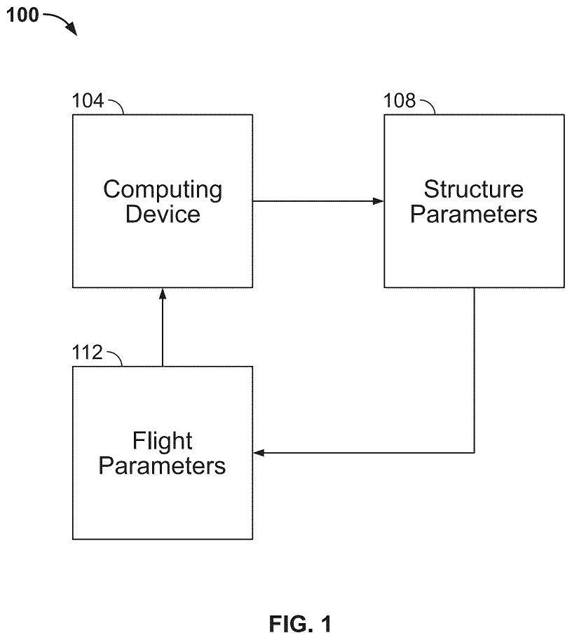

Referring now to FIG. 1, a dynamic topographical control system 100 (also referred to as “system 100”) for metamorphic structure is presented. A “metamorphic structure” as used in this disclosure refers to a structure able to change its shape while retaining it's structural integrity. Metamorphic structures may include, but are not limited to, wings, fins, and/or other structures. Metamorphic structures may be made out of a flexible material, such as a polymer or plastic. In some embodiments, metamorphic structures may be designed to change one or more dimensional attributes of themselves. Dimensional attributes may include, but are not limited to, lengths, heights, surface areas, and/or other dimensional attributes. In some embodiments, dynamic topographical control system 100 may be utilized in a fluid system. A fluid system may include any fluid, such as gas or liquid. For instance, system 100 may be used to control an aerial or aquatic vehicle. An aerial vehicle may include a fixed-wing plane or other aerial vehicle. An aquatic vehicle may include a boat, submarine, or other vehicle.

Computing device 104 may be configured to receive flight parameters 112 of an aerial vehicle. Flight parameters 112 may include, but are not limited to, pitch, roll, yaw, vibration, flutter, mass of a structure, inertial and/or dynamic forces, and/or friction or other flight parameters. Flight parameters 112 may be received via one or more sensors of an aerial vehicle that may be connected to computing device 104. Based on flight parameters 112, computing device 104 may calculate structure parameters 108. Structure parameters 108 may include but are no limited to, heights, lengths, widths, or other dimensions of one or more metamorphic structures. Computing device 104 may act as a control system, such as, but not limited to, a PID control system. For instance in a control system, angular velocity and/or angular acceleration may be included as flight parameters 112. In a control system utilizing computing device 104, there may be a maximum elongation of structure parameters 108 that may cause one or more metamorphic structures to structurally fail. One or more combinations of rotations of one or more metamorphic structures, which may be part of structure parameters 108, may cause one or more metamorphic structures to fail. A combination of shapes of one or more metamorphic structures, which may be output as structure parameters 108, may be optimized by computing device 104 based on flight parameters 112. Computing device 104 may be configured to determine tension, tension rate, tension acceleration, length, velocity of lengthening and/or shortening, and/or acceleration of lengthening and/or shortening of one or more devices used to morph one or more metamorphic structures. One or more devices may include, but are not limited to, cables, wires, ropes, strings, and/or other tension providing devices. Computing device 104 may enable theta, phi, and/or psi rotations within a control system of between about −60 to about +60 degrees, greater than about +60 degrees, or less than about −60 degrees.

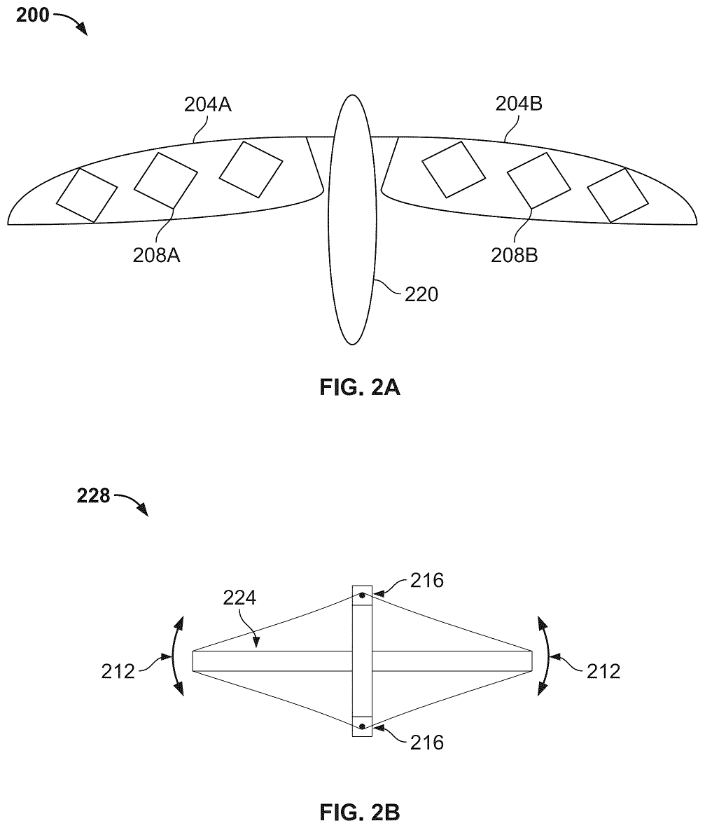

Referring now to FIG. 2A, an illustration of an aerial vehicle 200 is presented. In some embodiments, aerial vehicle 200 may not have rivets, land gear, flap joints, and/or rudder joints, which may allow for an increased payload of aerial vehicle 200. Aerial vehicle may include metamorphic structures 204A and 204B. Metamorphic structures 204A and 204B may be shaped as wings, which may provide lift to an aerial and/or aquatic body. Metamorphic structures 204A and/or 204B may be made of a uniform homogenous composite cross section. For instance, foamed, either nano, micro, or macro-cellular bubbles, uniform or gradient tailored composite foam cross sections. Combinations of material configures may include any materials described herein, without limitation. Metamorphic structures 204A, B, may form elastic truss elements, which may be made of both or either of homogenous and foamed cross sections. Metamorphic structures 204A, B, may be near 2D elastic structural members that may be joined together. Metamorphic structures 204A, B, may be subject to deformation out of plane when movements are applied, such as, but not limited to, bending, torsion, tension, and/or other movements. Metamorphic structures 204A, B, may form a wing of about 8 feet, greater than about 8 feet, or less than about 8 feet. Central body 220 may be round, square, rectangular, or other shapes. Central body 220 may be about 10 feet long, less than about 10 feet long, or greater than about 10 feet long. In some embodiments, central body 220 may have a tail, which may be about 4 feet or greater in width, or less than 4 feet in width. A tail of aerial vehicle 200 may be orthogonal or partially orthogonal to metamorphic structure 204A, B. A total weight of aerial vehicle 200 may be about 30 lbs, greater than about 30 lbs, or less than about 30 lbs. In some embodiments, aerial vehicle 200 may be additively manufactured using polymer composite additive systems. An additive manufacturing of aerial vehicle 200 may take less than or about 30 minutes, in some embodiments. One or more parts of aerial vehicle 200 may be joined together through one or more securing elements, such as, but not limited to, notched joints, screws, bolts, nails, rivets, tapes, thermal welding, ultrasonic welding, gluing, and/or solvent bonding. One or more parts of aerial vehicle 200 may be reinforced with duct tape, Kevlar tape, and/or other joining methods, which may structurally reinforce the one or more parts of aerial vehicle 200. Reinforced parts of aerial vehicle 200 may be intentionally flammable, in some embodiments. Aerial vehicle 200 may include a power source, such as one or more batteries or other power sources. A power source may include LiPo batteries, which may have an ability to intentionally melt electrical wiring or short circuit to ignite one or more portions of aerial vehicle 200. In some embodiments, aerial vehicle 200 may include a flammable gas tank with a torch.

Rather than conventional rib and skins or plates and shells of fixed wing aircraft, metamorphic structures 204A, B, may be encases in low-drag materials to form thin skins. Thin skins may have a likeness to the wings of dragonflies or other such insects. Low-drag materials that may form thin skins may include, but are not limited to, polymers, aluminum sheet metal, polymer sheets, and/or composites. Thin skins used in aerial vehicle 200 may provide a lightweight alternative to conventional methods, increased water resistance in comparison to conventional methods, and/or high local surface deformation capability to reduce inducement of turbulent vortices at tips of metamorphic structures 204A, B.

Metamorphic structures 204A and 204B may include flexors 208A and 208B. Flexors 208A and 208B may be portions of metamorphic structures 204A and 204B, respectively, that may cause metamorphic structures 204A and 204B to change one or more dimensional attributes. In some embodiments, each metamorphic structure may have a set of flexors, such as, but not limited to, a set of two or more flexors 208. Flexors 208A, B, may be connected to one or more pulleys, cables, ropes, or other tensioning devices. Flexors 208A, B, may be configured to provide a vertical and/or horizontal tension to each of metamorphic structures 204A, B, which may cause each of metamorphic structures 204A, B, to change in length, height, and/or width.

Referring now to FIG. 2B, an illustration of a metamorphic tail 228 is presented. metamorphic tail 228 may have movable edges 212. Moveable edges 212 may be connected to pulleys 216. Pulleys 216 may be connected to or include one or more gears. One or more gears of pulleys 216 may be connected to a power source via one or more electrical connections. Electrical connections may include, but are not limited to, copper wire, aluminum wire, silver wire, and/or other forms of conductive wiring. In some embodiments, pulleys 216 may be connected to moveable edges 212 via wires 224. Wires 224 may be straight or braided, in some embodiments. Wires 224 may be made of a polymer. In some embodiments, Pulleys 216 may cause moveable edges 212 to move vertically, such as in an upwards or downwards direction, which may cause part of metamorphic tail 228 to shorten or lengthen. Pulleys 216 may be controlled by a control device.

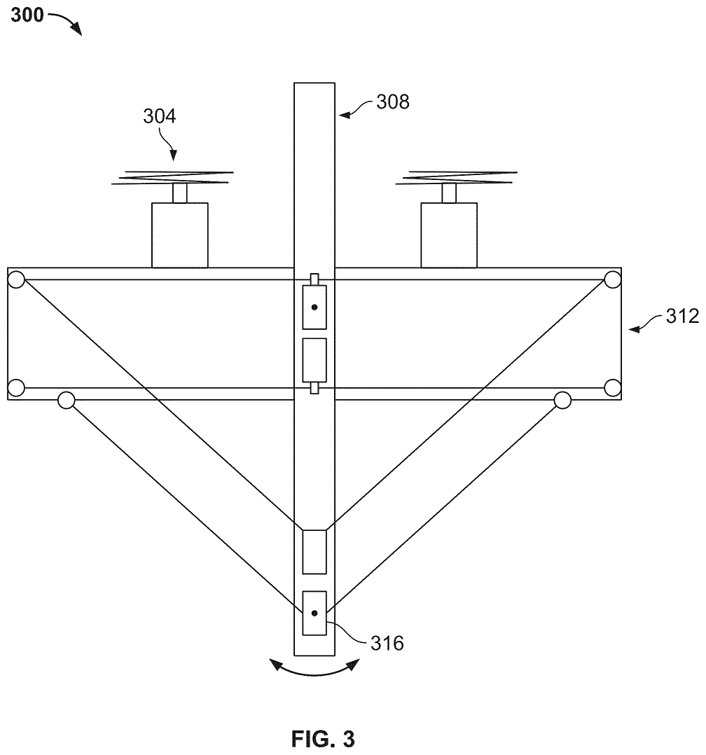

Referring now to FIG. 3, an embodiment of an aerial vehicle 300 is presented. Aerial vehicle 300 may include propellers 304, which may be positioned on each side of nose 308. Aerial vehicle 300 may include wings 312. Wings 312 may be rectangular shaped, in some embodiments. At a bottom of aerial vehicle 300, pulleys 316 may be positioned. A first pulley of pulleys 316 may be connected to a top portion of wings 312 via one or more ropes and a second pulley of pulleys 316 may be connected to a bottom portion of wings 312 via one or more ropes. Pulles 316 may pull on one or more ropes to shorted or widen one or more sides of wings 312.

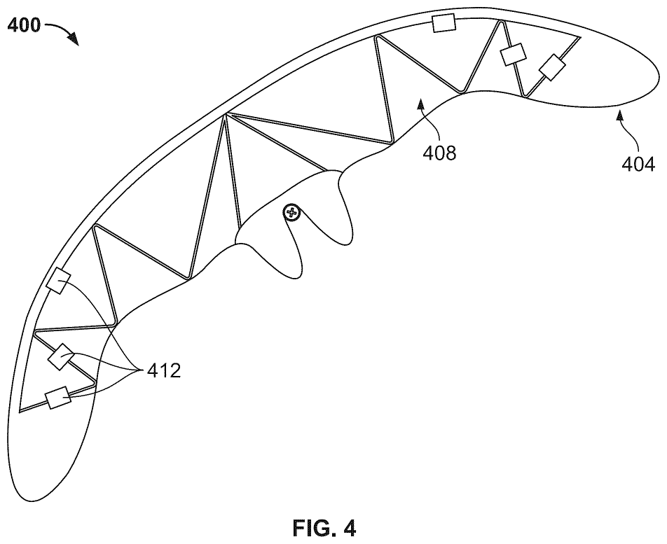

Referring now to FIG. 4, another illustration of an aerial vehicle 400 is presented. Aerial vehicle 400 may include wings 404. Wings 404 may be made of one solid material, in some embodiments. Wings 404 may include flexors 408. Flexors 408 may be configured to tension one or more portions of wings 404, which may cause one or more portions of wings 404 to shorten or lengthen. Flexors 408 may be connected to pulleys 412. Pulleys 412 may be configured to provide tension or relief of tension to one or more portions of flexors 408, which may cause one or more portions of wings 404 to shorten or lengthen.

In some embodiments, structural payloads may be attritable aerial vehicles incorporating metamorphic structures, USV hulls, UUV hulls, UGV chassis, and other attritable structures. A “structural payload” as used in this disclosure refers to an initially structurally sound structure which is intentionally compromisable to enhance a kinetic effect. Generally, structural payloads exhibit high mechanical performance with tensile, compression, and flexural modulus typically greater than 1 GPa and ultimate strength >10 MPa. Structural payloads may be used for any and all types of manned and unmanned vehicles—unmanned being a preferred embodiment. In some embodiments, structural payloads of attritable autonomous structures may include polymer composite materials that may be flammable, combustible, or explosive in nature. Of particular use are polymers which release water as a combustion reaction primary reaction product or byproduct. In some embodiments, a flammable polymer composite may be foamed using an oxidizing or reacting gas to reduce density by approximately 1%-80%. In some embodiments the structural payload may be saturated, about 1% to about 80% by mass, with a reactant, such as, but not limited to, H2, methane, propane, kerosene, gasoline, and/or other oxidizing agents, and/or an accelerant such as, but not limited to oxygen, ozone, potassium chlorate, sodium perchlorate, etc. In some embodiments, structural payloads may include semi-stable solids, such as, but not limited to, pellets, powders, wires, fibers, and/or other materials which may possess high energy density and high reactivity, such as, but not limited to, magnesium, thermite, sulfites, sulfates, aluminum, activated aluminum, nitrates, and/or other reactive solids. Any combination of any structural payloads described herein may be used, without limitation. Structural payloads may include flammable gas tanks with torches, in some embodiments. A balloon, such as a hydrogen balloon, may be incorporated into a structural payload of one or more aerial vehicles described herein.

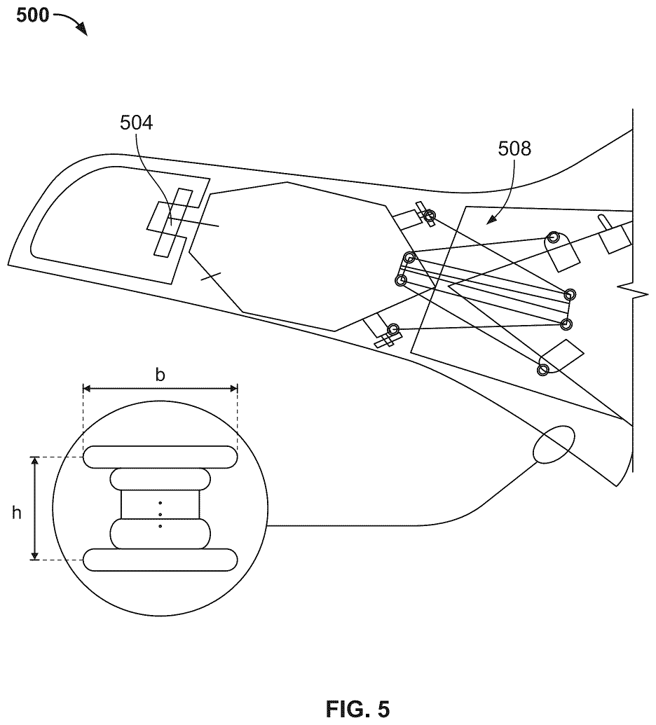

Referring now to FIG. 5, a depiction of a motor-pulley system 500 are presented. A motor-pulley system 500 may include pulley 504 and wires 508. Pulley 504 may include a motor. Pulley 504 may be mounted on a wing or other structure via a printed mount. In some embodiments, pulley 504 may include a bearing stiffener. A metamorphic structure may have a perpendicular cross cut at an edge of the metamorphic structure.

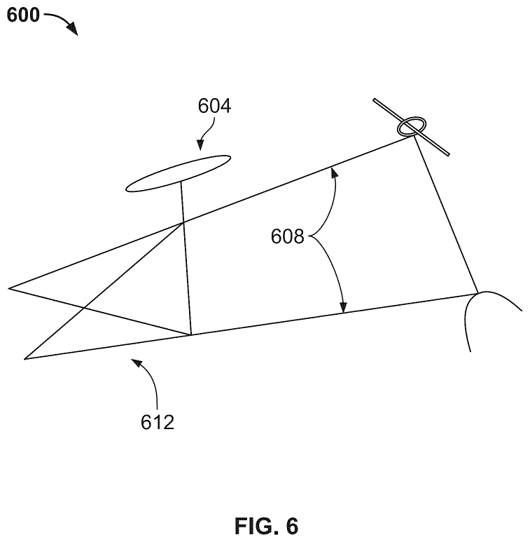

Referring now to FIG. 6, a metamorphic bike 600 is presented. Metamorphic bike 600 may include seat 604, truss mounts 608, and/or flexure trusses 612.

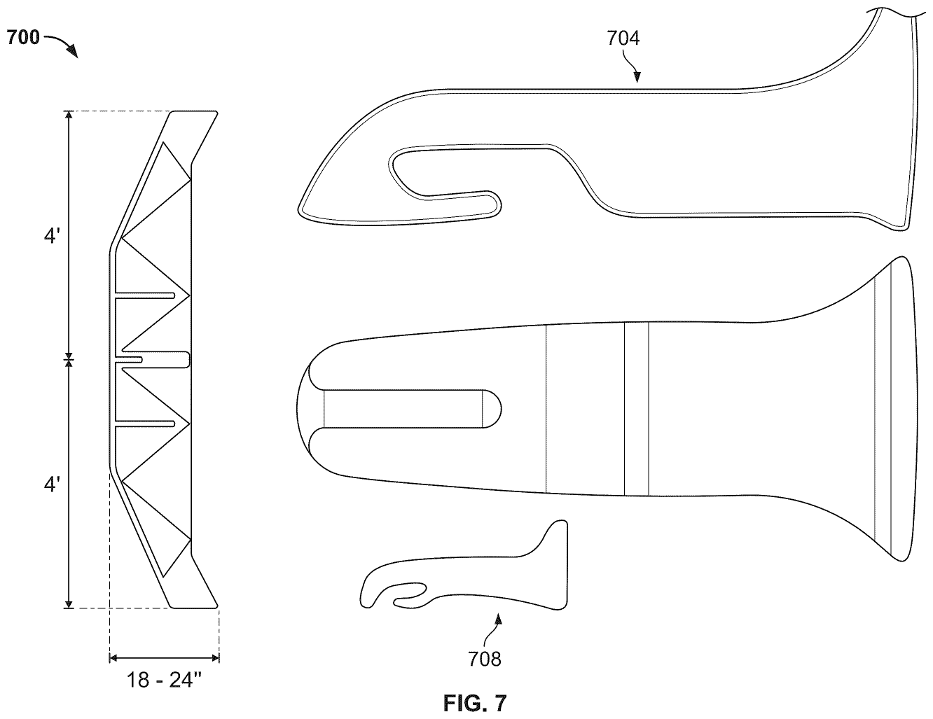

Referring now to FIG. 7, a wing and body subsystem 700 is shown. Wings 704 may be configured to connect to body 708. In some embodiments, wings 704 may have curved edge 712. Curved edge 712 may be configured to connect to a concavity 716 of body 708. In some embodiments, wings 704 may be pulled in a horizontal and/or vertical direction to allow curved edge 712 to fit inside concavity 716, which may allow for a coupling of wings 704 and body 708.

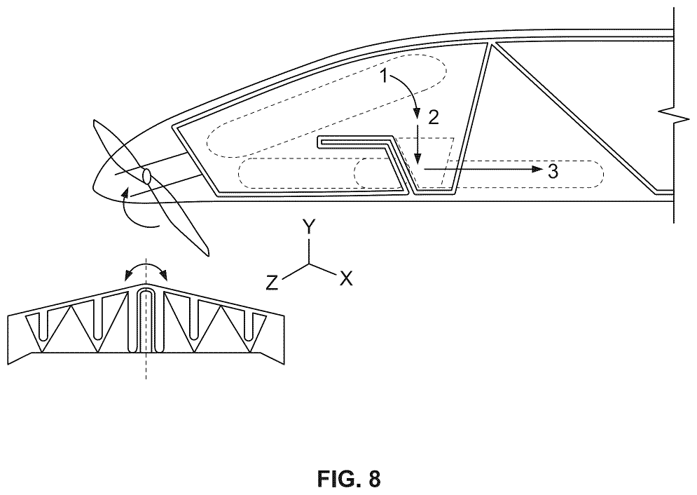

Referring now to FIG. 8, another embodiment of a wing and body subsystem 800 is shown.

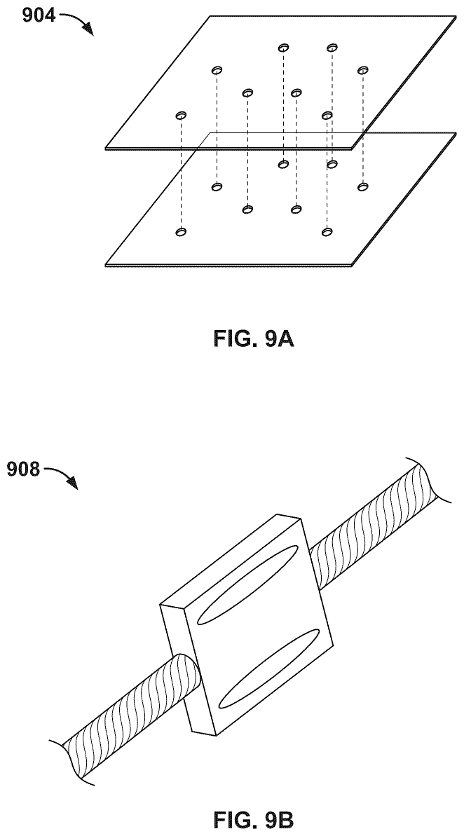

Referring now to FIG. 9A, a tensile harmonic manifold control surface 900 is presented. Tensile harmonic manifold control surface 900 (also referred to as “surface 900”) may have a top surface and a bottom surface which may be connected by one or more tension devices. A mobius twist may be used to store energy of surface 900. Plucking of surface 900 may cause acoustic, mechanical, and/or other vibrations. By connecting top and bottom surfaces, lines in tension may put the top and bottom surfaces in compound compression, tension, and/or torsion. Simple or complex buckling may ensue. Buckling may result in complex shapes with unique, geometrically similar Eigen solutions which may identify a high-order resonant buckling mode. An elastic tension and elastic structural material may allow a higher elastic buckling mode to manifest. Harmonic resonance in tensile members, such as, but not limited to, cables, wires, and/or ropes, may induce a switching between positive and negative Eigen solutions of surface 900. A controlling of surface 900 may allow surface 900 to flip from an up position to a down buckled shape, or vice versa. A crossing of one or more semi-connected tensile members may act like a Mobius twist in surface 900. By resonating one or more tensile members of surface 900, resonant states of surface 900 may be switched. At a peak resonance, surface 900 may oscillate between semi-unstable buckling states.

Referring now to FIG. 9B, a non-stationary point rotation device 908 is presented. Non-stationary point rotation device 908 may be a motor that may intentionally be moved relative to a structure in which the motor is mounted. Relative angles between tensile members and structural members may be continuously modified via non-stationary point rotation device 908. A coordination of point rotations and/or movement of point rotations with respect to neutral axes of compliant structures and/or resonance of structures may enable a harmonic switching to occur rapidly. In some embodiments, non-stationary point rotation device 908 may be a cable crawler. A cable crawler may move along a cable or wire via eddy currents, friction, tracks, conveyors, worms, screws, and/or other driving mechanism. Non-stationary point rotation device 908 may be configured to move in a positive or negative direction along a wire or cable.

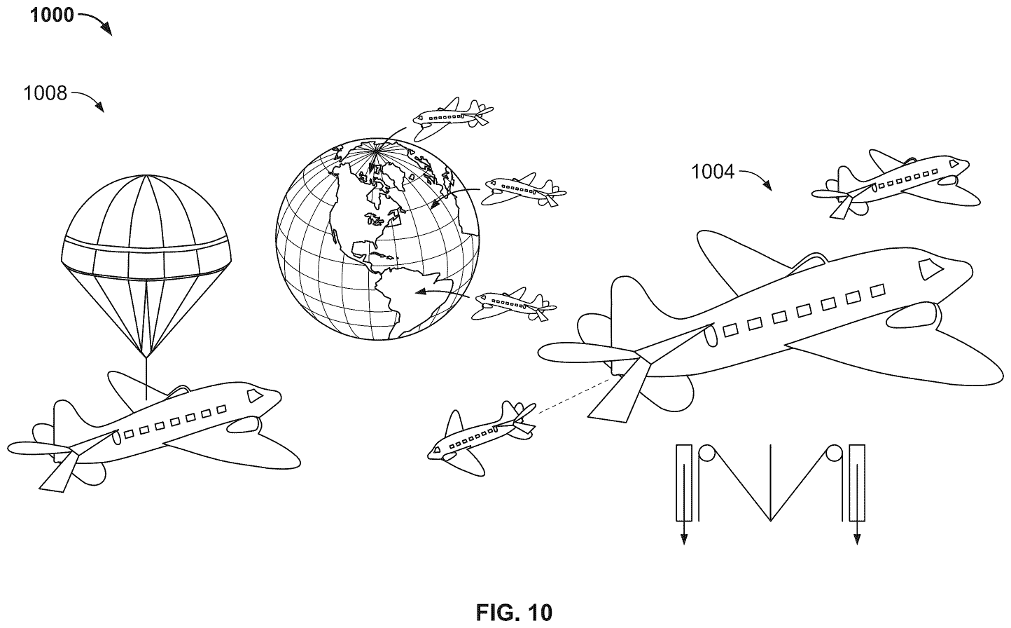

Referring now to FIG. 10, a deployment of unmanned aerial vehicles 1000 is presented. Deployment 1000 may include carrier 1004 and unmanned vehicle 1008. Carrier 1008 may be a large aircraft that may store unmanned vehicle 1008. Unmanned vehicle 1008 may be configured to take flight from a ground surface, be shoulder launched, or other wise take flight, in some embodiments. Unmanned vehicle 1008 may be tied to one or more balloons, which may provide an upwards lift to unmanned vehicle 1008. A variety of deployment mechanisms of unmanned vehicle 1008 may take place, such as, but not limited to, orbital drops, actuated launch from within a cargo of carrier 1004, and/or ground launching unmanned vehicle 1004 via ballista, trebuchet, catapult, or electromagnetic rail gun.

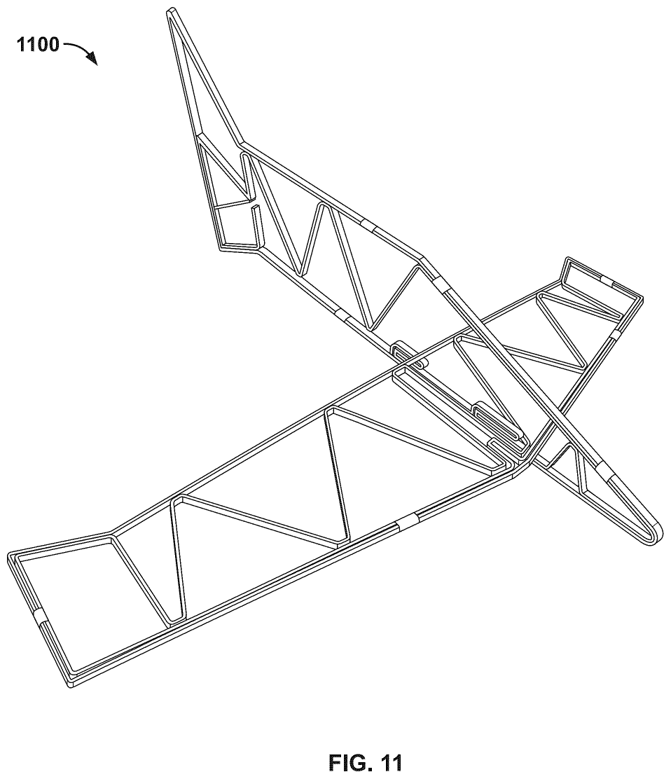

Referring now to FIG. 11, an illustration of an aerial vehicle 1100 is presented. An aerial vehicle may be made of one or more metamorphic structures. Metamorphic structures may include flexors. Each flexor may be configured to rotate vertically and/or horizontally relative to adjacent flexors.

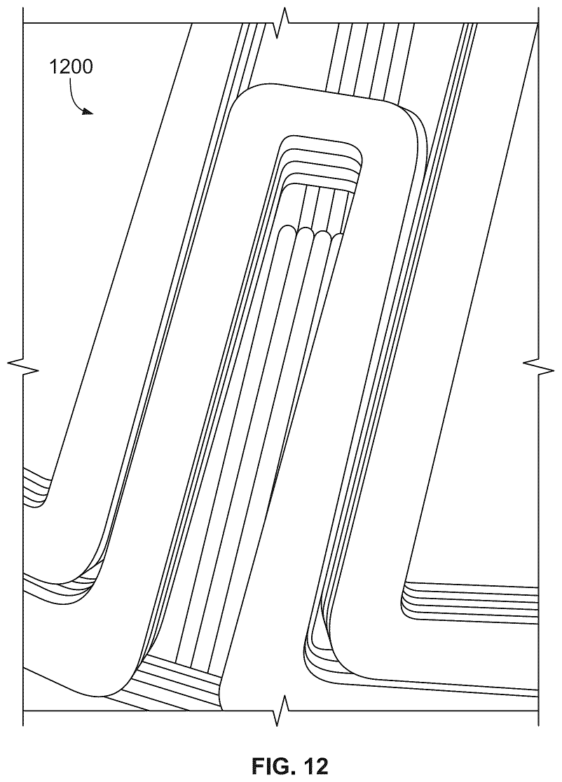

Referring now to FIG. 12, an illustration of a joint 1200 is presented.

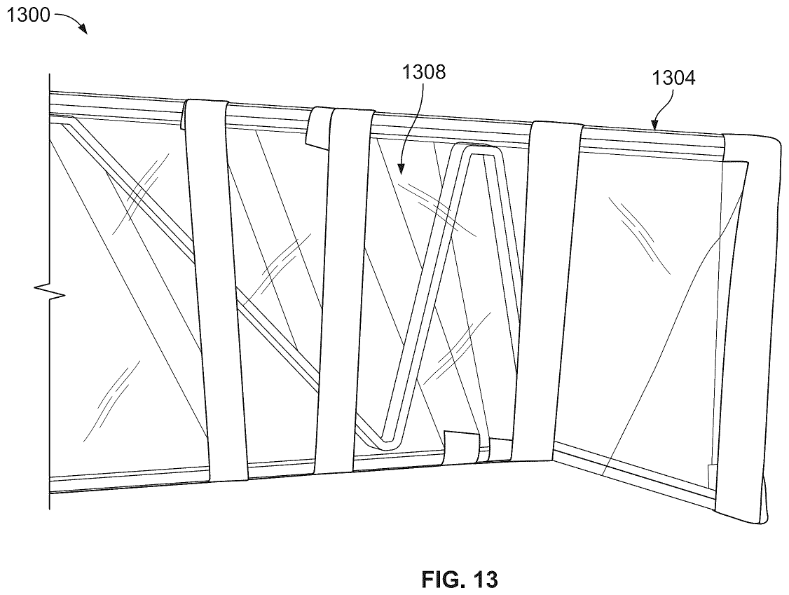

Referring now to FIG. 13, an illustration of a truss 1300 is presented. Truss 1300 may include thin skin 1304 and/or thick skin 1308.

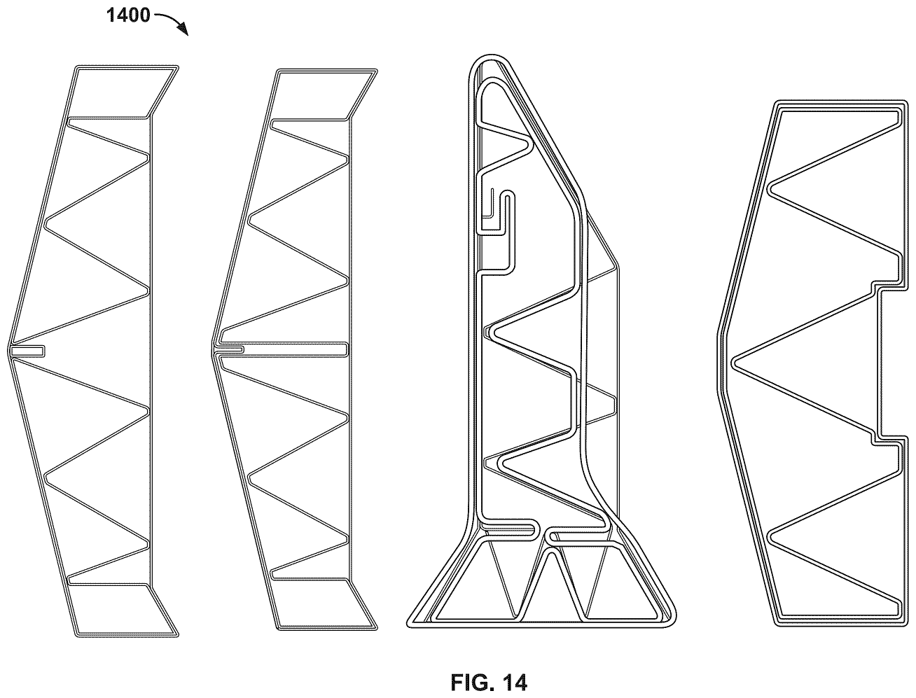

Referring now to FIG. 14, an illustration of a tool path of a wing 1400 is presented.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other steps or stages may be provided, or steps or stages may be eliminated, from the described processes. Accordingly, other implementations are within the scope of the following claims.

What is claimed is:

1. A dynamic topographical control system for metamorphic structures, comprising:
A computing device configured to:
receive flight parameters of at least a metamorphic structure; and
calculate structure parameters of the at least a metamorphic structure based on at least the flight parameters; and
update the structure parameters based on new flight parameters caused by updated structure parameters.

2. The system of claim 1, wherein the structure parameters include one or more of height and length of the at least a metamorphic structure.

3. The system of claim 1, wherein the flight parameters include one or more of yaw, pitch, or roll.

4. The system of claim 1, wherein the computing device is further configured to activate one or more pulleys to adjust the structure parameters of the at least a metamorphic structure.

5. The system of claim 4, wherein the pulleys allow up theta, phi, and psi rotations within a control system of about 60 degrees.

6. The system of claim 1, wherein the computing device is further configured to calculate the structure parameters through a machine learning model.

7. The system of claim 1, wherein the computing device is further configured to activate a structural payload of a vehicle.

8. A dynamic topographical metamorphic structure for aerial flight, comprising:
an aerial body having:
a first wing, the first wing comprising:
a first metamorphic structure, the at least a first metamorphic structure configured to change its dimensional attributes while retaining structural integrity;
a first cable connected to the at least a first metamorphic structure; and
a first pulley connected to the first cable, wherein the first pulley is configured to provide a force on the first cable to change one or more dimensional attributes of the first metamorphic structure;
a second wing, the second wing comprising:
a second metamorphic structure, the second metamorphic structure configured to change its dimensional attributes while retaining structural integrity;
a second cable connected to the at least a first metamorphic structure; and
a second pulley connected to the cable, wherein the pulley is configured to provide a force on the cable to change one or more dimensional attributes of the second metamorphic structure; and
a control device in communication with the first and second pulleys, the control device configured to activate the first and/or second pulley to change dimensional attributes of the first and/or second metamorphic structure to adjust flight parameters of the aerial body.

9. The structure of claim 8, wherein the one or more dimensional attributes include one or more of height, length, width.

10. The structure of claim 8, wherein the first and second metamorphic structures are made of a plurality of flexors.

11. The structure of claim 10, wherein each flexor of the plurality of flexors is configured to rotate in a vertical direction.

12. The structure of claim 8, wherein the control device is further configured to adjust a tension, tension rate, tension acceleration, length, velocity of lengthening, velocity of shortening, acceleration of lengthening or acceleration of shortening of the first or second cables.

13. The structure of claim 8, wherein each metamorphic structure is reinforced with a thin skin material.

14. The structure of claim 13, wherein the thin skin material is flammable.

15. A method of operating a metamorphic structure, comprising:
activating a pulley connected to a portion of a metamorphic structure, wherein activation of the pulley causes a changing in dimensional attributes of the metamorphic structure.
